(19) United States
(12) Patent Application Publication
(10) Pub. No.: US 2010/0040916 A1
(43) Pub. Date: Feb. 18, 2010

(54) Methods and Systems for Generating Hydrogen From a Biomass

(76) Inventors: Marco J. Castaldi, New York, NY (US); Kartik Chandran, New York, NY (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 12/301,056

(22) PCT Filed: May 31, 2007
(86) PCT No.: PCT/US07/70033

§ 371 Date: Jun. 8, 2009

Related U.S. Application Data
(60) Provisional application No. 60/810,012, filed on May 31, 2006.

(51) Int. Cl. H01M 8/04; H01M 8/18; C01B 3/06; B01J 19/00

(52) U.S. Cl. 429/17; 429/19; 423/658.2; 422/148

(57) ABSTRACT

Methods and systems for producing hydrogen from a biomass are disclosed. In some embodiments, the method includes decomposing a biomass to produce an aqueous effluent including nitrogen species, generating ammonia from the nitrogen species, combusting the ammonia in the presence of catalysts to decompose the ammonia to hydrogen and nitrogen, and combusting a portion of the hydrogen and the nitrogen to provide heat for combusting the ammonia. In some embodiments, the system includes a bioreactor for decomposing a biomass to produce an aqueous effluent including nitrogen species, a mechanism for generating ammonia gas from the nitrogen species, a catalytic reforming reactor for converting the ammonia gas to hydrogen gas and nitrogen gas, a combustor for combusting a portion of the hydrogen gas and the nitrogen gas to provide heat for converting the ammonia gas, and a separator for isolating the hydrogen gas.

### CROSS REFERENCE TO RELATED APPLICATION(S)

This application claims the benefit of U.S. Provisional Application No. 60/810,012, filed May 31, 2006, which is incorporated by reference as if disclosed herein in its entirety.

### BACKGROUND

The ever-increasing global demand for energy has sparked renewed interest in the study of sustainable alternative energy sources. As a result, the demand for hydrogen has increased. Production of hydrogen in the United States is currently in excess of 3 billion cubic feet per year and is expected to increase significantly.

Hydrogen is used as an alternative fuel for engines in machinery and motor vehicles in fuel cells or more directly in combustion engines. The successful use of hydrogen as an alternative to carbon fuels sources can provide significant benefits to the environment and impact world politics by decreasing the dependence of countries on petroleum fuels. Hydrogen burns clean and does not produce carbon dioxide or greenhouse gasses.

Know methods of producing hydrogen exist. Electrolysis is commonly used to decompose water into hydrogen and oxygen. However, significant amounts of electricity are required to power the electrolysis process. Another known process for generating hydrogen is steam reforming. Steam reforming is expensive and can be environmentally unfavorable because it uses fossil fuels as an energy source.

### SUMMARY

Methods for producing hydrogen from a biomass are disclosed. In some embodiments, the method includes the following: decomposing a biomass to produce an aqueous effluent including nitrogen species; generating ammonia from the nitrogen species; decomposing the ammonia in the presence of catalysts to decompose the ammonia to hydrogen and nitrogen; and combusting a portion of the hydrogen and the nitrogen to provide heat for combusting the ammonia.

Methods for generating a consumable energy from a biomass are disclosed. In some embodiments, the method includes the following: decomposing a biomass to produce an aqueous effluent including nitrogen species; generating ammonia from the nitrogen species; catalytically reacting the ammonia to convert the ammonia to hydrogen and nitrogen; separating the hydrogen from the nitrogen; feeding the hydrogen to a fuel cell or storing for chemical synthesis; and generating a consumable energy with the fuel cell.

Systems for generating hydrogen from a biomass are disclosed. In some embodiments, the system includes the following: a bioreactor for decomposing a biomass to produce an aqueous effluent including nitrogen species; a mechanism for generating ammonia gas from the nitrogen species; a catalytic reforming reactor for converting the ammonia gas to hydrogen gas and nitrogen gas; a combustor for combusting a portion of the hydrogen gas and the nitrogen gas to provide heat for converting the ammonia gas; and a separator for isolating the hydrogen gas.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a diagram of a system according to some embodiments of the disclosed subject matter; and

FIG. 2 is a diagram of a process according to some embodiments of the disclosed subject matter.

### DETAILED DESCRIPTION

Generally, the disclosed subject matter relates to systems and methods for generating hydrogen from a biomass. The biomass is decomposed to an aqueous effluent that includes hydrogen. The aqueous effluent is processed to produce ammonia, which is further processed to produce hydrogen and nitrogen gases. The hydrogen gas is separated and can be used in a generator or fuel cell to produce electricity.

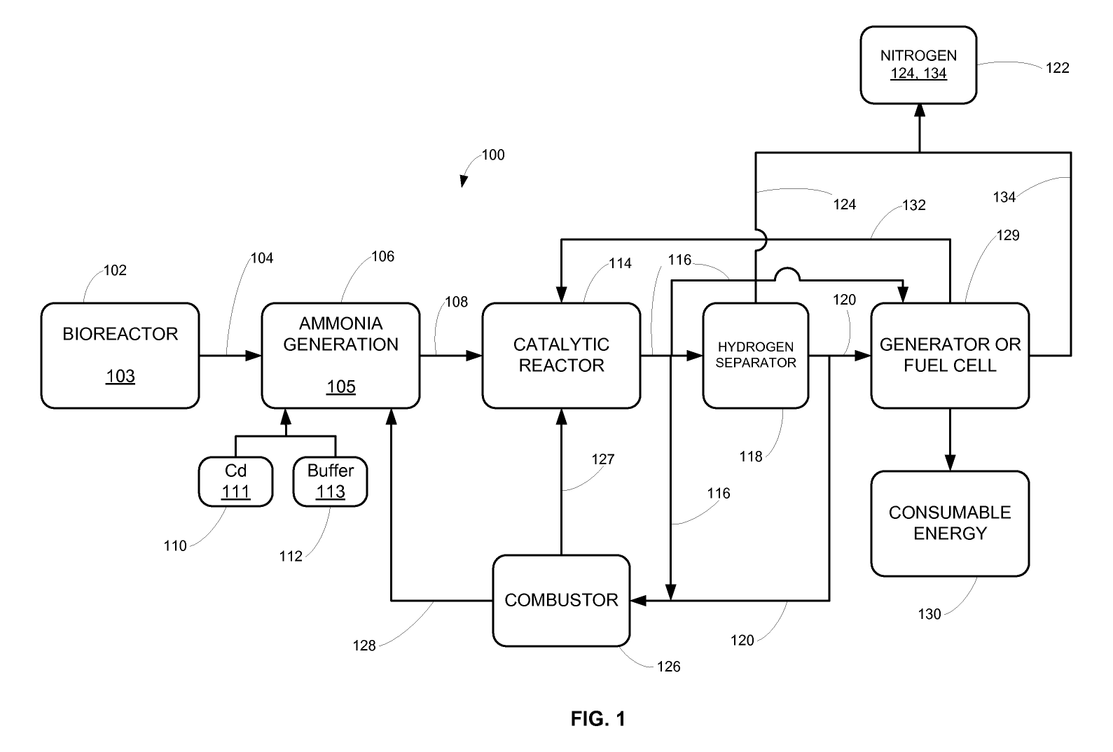

Referring now to FIG. 1, one embodiment of the disclosed subject matter is a system 100 for generating hydrogen from a biomass, e.g., a sanitary wastewater, a municipal solid waste (MSW), etc. System 100 includes a bioreactor 102 for decomposing a biomass 103 to produce an aqueous effluent 104 including nitrogen species 105. System 100 includes a tank or other vessel 106 to contain aqueous effluent 104 as it is further processed to generate an ammonia gas 108.

System 100 includes a mechanism for generating ammonia gas 108. In some embodiments, system 100 includes a tank 110 that is used to contain cadmium (Cd) 111, which can be added to aqueous effluent 104 in tank 106 to reduce nitrogen species 105 to ammonia gas 108. In some embodiments, system 100 includes a tank 112 that is used to contain a buffer solution 113, e.g., calcium oxide (CaO), sodium hydroxide (NaOH), or similar, which can be injected into tank 106 to alter the pH of aqueous effluent 104 such that ammonia gas 108 is released from the effluent. CaO is typically less expensive than NaOH. It has been found that a pH of about 11 is required to cause ammonia gas 108 to be released from the effluent. Aqueous effluent 104 can be treated using additional denitrification processes.

System 100 includes a catalytic reforming reactor 114 for catalytically decomposing ammonia gas 108 to a mixture 116 of hydrogen gas and nitrogen gas. Catalytic reforming reactor 114 can include a rhodium or nickel catalyst in either a packed-bed or monolith form and at a temperature of between about 550 and 650 degrees Celsius. Nickel catalysts have been found to cost less than a rhodium catalyst over its lifetime of effective use. However, rhodium catalysts have been found to decompose ammonia at a faster rate and have a lower fouling rate than nickel catalysts. Monolith reactors have been found to have a lower pressure drop than packed bed reactors.

System 100 can include a separator 118 for separating a hydrogen gas 120 from mixture 116 and a tank or vessel 122 for containing a nitrogen gas 124 remaining from the mixture. Separator 118 can be a palladium membrane or other known technology for separating hydrogen such as pressure swing adsorption.

System 100 generally, but not always, includes a combustor 126 for combusting a portion of either mixture 116 of hydrogen gas and nitrogen gas or hydrogen gas 120 to provide a heat energy 127 to catalytic reforming reactor 114 for converting ammonia gas 108 to the mixture of hydrogen gas and nitrogen gas. About 30% by weight of mixture 116, or an equivalent amount of hydrogen gas 120, can be combusted in combustor 126 to provide heat energy 127 to catalytic reforming reactor 114. In some embodiments, an amount 128 of hydrogen is provided to tank 106 from combustor 126.

System 100 can include or be connected with a mechanism 129 for generating a consumable energy 130 such as electricity. The remaining amount, e.g., 70% by weight of either mixture 116 or hydrogen gas 120, can be used as a fuel source to mechanism 129. In some embodiments, mechanism 129 is a hydrogen-powered generator. In some embodiments, mechanism 129 is a fuel cell. An exhaust 132 generated by mechanism 129 can be combusted in catalytic reforming reactor 114. Where mixture 116 is used as a fuel source, the operating parameters of mechanism 129 can be controlled to ensure that exhaust 132 does not produce nitrous oxide. For example, the operating temperature of a generator can be kept at or below 1500 degrees Celsius. A stream of nitrogen gas 134 can be captured from mechanism 129 and stored in tank 122 or released to the atmosphere as an inert nitrogen gas.

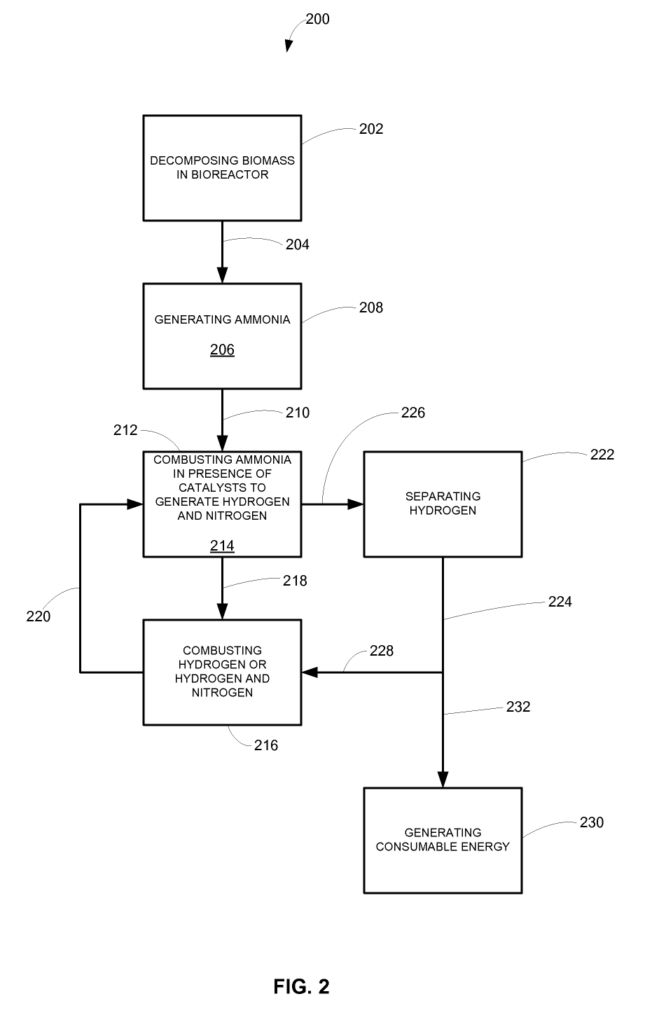

Referring now to FIG. 2, another aspect of the disclosed subject matter is a method 200 of producing hydrogen from a biomass such as a sanitary wastewater, a MSW, etc. At 202, biomass is decomposed to produce an aqueous effluent 204 including nitrogen species 206. At 208, ammonia 210 is generated from nitrogen species 206. As shown in equations (1) and (2) below, in some embodiments, ammonia 210 can be generated by injecting a buffer solution, e.g., calcium oxide (CaO) or similar, into aqueous effluent 204 to change the pH of the aqueous effluent thereby causing a release of ammonia:

CaO+H₂O═Ca(OH)₂ (1)

Ca(OH)₂+NH₄⁺═Ca²⁺+H₂O+NH₃. (2)

In some embodiments, ammonia 210 can be generated by adding cadmium to aqueous effluent 204 thereby reducing a portion of nitrogen species 206 to generate ammonia.

As shown by equation (3), at 212, ammonia 210 is combusted in the presence of catalysts to decompose the ammonia to a mixture 214 of hydrogen and nitrogen:

NH₃=1/2N₂+3/2H₂ (3)

At 216, an amount 218 of mixture 214 is combusted to provide heat (as indicated by arrow 220) for combusting ammonia 210.

At 222, a hydrogen stream 224 is separated from an amount 226 of mixture 214. In some embodiments, hydrogen is separated using a palladium membrane. An amount 228 of hydrogen stream 224 can be combusted to provide heat (at 216) for decomposing ammonia 210. At 230, an amount 232 of hydrogen stream 224 can be used as a fuel source to a generator or fuel cell to generate electricity.

Systems and methods according to the disclosed subject matter provide a sustainable alternative energy source. The product of a wastewater denitrification process serves as a source of hydrogen via a catalytic decomposition reaction.

Systems and methods according to the disclosed subject matter can be easily integrated into existing wastewater treatment plants. Since ammonia constitutes the largest form of nitrogen, systems and methods according to the disclosed subject matter can significantly reduce the loading on the subsequent removal system. This can lower the costs of the other techniques significantly by reducing the quantity to be processed. The process can also reduce the amount of carbon dioxide that can be generated using nitrification-denitrification process.

Some advantages of systems or methods according to the disclosed subject matter are that it is easily integrated into existing systems and it reduces the treatment costs to the facility while also saving energy. By reducing the nitrogen loading up to 60%, systems or methods according to the disclosed subject matter significantly lower annual treatment costs to the facility. Systems or methods according to the disclosed subject matter could even be used as a stand alone technique in niche applications where the wastewater has either low total nitrogen and/or a high ammonia percentage (of the total nitrogen). In these circumstances, systems or methods according to the disclosed subject matter could be the sole nitrogen removal system as long as it is able to reduce the nitrogen concentration below effluent standards.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. A method of producing hydrogen from a biomass, said method comprising:
decomposing a biomass to produce an aqueous effluent including nitrogen species;
generating ammonia from said nitrogen species;
decomposing said ammonia in the presence of catalysts to decompose said ammonia to hydrogen and nitrogen; and
combusting a portion of said hydrogen and said nitrogen to provide heat for catalytically reacting said ammonia.

2. The method according to claim 1, wherein said biomass is a sanitary wastewater.

3. The method according to claim 1, further comprising injecting a buffer solution into said aqueous effluent to change the pH of said aqueous effluent thereby causing a release of ammonia.

4. The method according to claim 1, further comprising adding cadmium to said aqueous effluent thereby reducing a portion of said nitrogen species to generate ammonia.

5. The method according to claim 1, further comprising generating a consumable energy with a portion of said hydrogen.

6. The method according to claim 1, further comprising separating a portion of said hydrogen.

7. The method according to claim 6, wherein said portion of said hydrogen is separated using a palladium membrane or pressure swing adsorption.

8. A method of generating a consumable energy from a biomass, said method comprising:
decomposing a biomass to produce an aqueous effluent including nitrogen species;
generating ammonia from said nitrogen species;
catalytically reacting said ammonia to convert said ammonia to hydrogen and nitrogen;
separating said hydrogen from said nitrogen;
feeding said hydrogen to a fuel cell; and
generating a consumable energy with said fuel cell.

9. The method according to claim 8, wherein said biomass is a sanitary wastewater.

10. The method according to claim 8, further comprising injecting a buffer solution into said aqueous effluent to change the pH of said aqueous effluent thereby causing a release of ammonia.

11. The method according to claim 8, further comprising adding cadmium to said aqueous effluent thereby reducing a portion of said nitrogen species to generate ammonia.

12. The method according to claim 8, wherein said hydrogen is separated using a palladium membrane.

13. A system for generating hydrogen from a biomass, said system comprising:
a bioreactor for decomposing a biomass to produce an aqueous effluent including nitrogen species;
means for generating ammonia gas from said nitrogen species;
a catalytic reforming reactor for converting said ammonia gas to hydrogen gas and nitrogen gas;
a combustor for combusting a portion of said hydrogen gas and said nitrogen gas to provide heat for converting said ammonia gas; and
a separator for isolating said hydrogen gas.

14. The system according to claim 12, wherein said biomass is a sanitary wastewater.

15. The system according to claim 12, wherein said means for generating ammonia includes injecting a buffer solution into said aqueous effluent to change the pH of said aqueous effluent thereby causing a release of ammonia.

16. The system according to claim 12, wherein said means for generating ammonia includes adding cadmium to said aqueous effluent thereby reducing a portion of said nitrogen species to generate ammonia.

17. The system according to claim 12, wherein said separator includes a palladium membrane.

18. The system according to claim 12, further comprising a means for generating a consumable energy.

19. The system according to claim 18, wherein said means for generating a consumable energy includes a hydrogen-powered generator.

20. The system according to claim 12, wherein said means for generating a consumable energy includes a fuel cell.
